(19) United States
(12) Patent Application Publication
(10) Pub. No.: US 2016/0343287 A1
(43) Pub. Date: Nov. 24, 2016

(54) LIQUID CRYSTAL DISPLAY APPARAUS AND CONTROL METHOD THEREOF

(71) Applicant: SHENZHEN CHINA STAR OPTOELECTRONICS TECHNOLOGY CO., LTD., Shenzhen, Guangdong (CN)

(72) Inventors: Fengcheng XU, Shenzhen, Guangdong (CN); Dongsheng GUO, Shenzhen, Guangdong (CN); Zhaolin FANG, Shenzhen, Guangdong (CN)

(73) Assignee: Shenzhen China Star Optoelectronics Technology Co., Ltd., Shenzhen, Guangdong (CN)

(21) Appl. No.: 14/437,487

(22) PCT Filed: Jan. 28, 2015
(86) PCT No.: PCT/CN2015/071713

§ 371 Date: Apr. 21, 2015

(30) Foreign Application Priority Data
Dec. 31, 2014 (CN) 201410856667.1

(51) Int. Cl. G09G 3/20; G09G 3/36; G09G 3/00

(52) U.S. Cl. CPC G09G 3/2018; G09G 3/003; G09G 3/36; G09G 2300/0426; G09G 2310/0291; G09G 2320/0209; G09G 2330/021; G09G 2320/0252; G09G 2310/027

(57) ABSTRACT

The present invention discloses a liquid crystal display apparatus and control method thereof. The liquid crystal display apparatus comprises: a plurality of data lines; a digital to analog converter disposed with a plurality of digital to analog converting channels corresponding to the data lines for converting a plurality of digital grey voltages into a plurality of analog grey voltages applied on the data lines, respectively; a switch circuit receiving a control signal and switching in accordance with the control signal, wherein, when the control signal is a first control signal, the switch circuit is switched to apply the analog grey voltages to the data lines to display a normal image frame by the liquid crystal display apparatus, and is switched to apply a reference voltage to the data lines when the control signal is a second control signal so as to display an inserted black frame by the liquid crystal display apparatus. By the solution above, crosstalk generated therefrom can be effectively reduced, power consumption generated due to displaying black frames is saved, and the response of a next frame is faster.

### FIELD OF THE INVENTION

The present invention relates to a field of liquid crystal display, and more particularly to a liquid crystal display apparatus and control method thereof.

### BACKGROUND OF THE INVENTION

The crosstalk of a liquid crystal display apparatus is reduced by using black frame insertion in an active shutter 3D technology, i.e. method of time-sharing. The primary theory is to insert a black frame between two frames so that a grey residual image is covered by the black frame to achieve the object of reducing crosstalk. Because the black frames are inserted by the conventional black frame insertion technology, data of black frames have to be output from a time controller (TCON) and power consumption occurs due to the insertion of the black frames.

### SUMMARY OF THE INVENTION

Accordingly, the present invention provides a liquid crystal display apparatus and control method thereof so as to reduce crosstalk generated therein, save power consumption generated when displaying the black frame, and enhance response speed of the next frame.

In order to solve the problem mentioned above, a liquid crystal display apparatus provided by the present invention comprises: a plurality of data lines; a digital to analog converter disposed with a plurality of digital to analog converting channels corresponding to the data lines for converting a plurality of digital grey voltages into a plurality of analog grey voltages applied on the data lines, respectively; and a switch circuit, which receives a control signal and switches in accordance with the control signal, wherein the switch circuit is switched to apply the analog grey voltages to the data lines when the control signal is a first control signal so as to display a normal image frame by the liquid crystal display apparatus, and is switched to apply a reference voltage to the data lines when the control signal is a second control signal so as to display an inserted black frame by the liquid crystal display apparatus; wherein, the switch circuit comprises a plurality of switching units corresponding to the digital to analog converting channels, each switching unit comprises a first switch and a second switch, a first end of the first switch is coupled to receive the control signal, a second end of the first switch is coupled to receive the analog grey voltage, and a third end of the first switch is coupled to receive the reference voltage; a first end of the second switch is coupled to receive the control signal, a second end of the second switch is coupled to receive the analog grey voltage, and a third end of the second switch is coupled to the data line; wherein, when the control signal is a first control signal, the first switch is turned on and the second switch is turned off to apply the analog grey voltage to the data line through the first switch, and, when the control signal is a second control signal, the first switch is turned off and the second switch is turned on to apply the reference voltage to the data line through the second switch; the liquid crystal display apparatus is a three-dimensional display apparatus, the normal image frame is a left-eye image frame and a right-eye image frame, and the inserted black frame is between the neighbored left-eye image frame and right-eye image frame.

Wherein, one of the first switch and the second switch is an NMOS, and another one of the first switch and the second switch is a PMOS.

Wherein, the liquid crystal display apparatus further comprises a buffer, the switch circuit is set between the buffer and the digital to analog converter; when the control signal is the first control signal, the switch circuit is switched to input the analog grey voltage to the buffer so that the analog grey voltage is outputted to the data line after being buffered by the buffer, and, when the control signal is the second control signal, the switch circuit is switched to input the reference voltage to the buffer so that the reference voltage is outputted to the data line after being buffered by the buffer.

Wherein, the liquid crystal display apparatus further comprises a plurality of pixel electrodes and a common electrode disposed oppositely to the pixel electrodes, wherein the pixel electrodes are coupled to the corresponded data lines, a common voltage is applied on the common electrode, and the reference voltage is equal to the common voltage.

In order to solve the problem mentioned above, a liquid crystal display apparatus provided by the present invention comprises: a plurality of data lines; a digital to analog converter disposed with a plurality of digital to analog converting channels corresponding to the data lines for converting a plurality of digital grey voltages into a plurality of analog grey voltages applied on the data lines, respectively; and a switch circuit, which receives a control signal and switches in accordance with the control signal, wherein the switch circuit is switched to apply the analog grey voltages to the data lines when the control signal is a first control signal so as to display a normal image frame by the liquid crystal display apparatus, and is switched to apply a reference voltage to the data lines when the control signal is a second control signal so as to display an inserted black frame by the liquid crystal display apparatus.

Wherein, the switch circuit comprises a plurality of switching units corresponding to the digital to analog converting channels, each switching unit comprises a first switch and a second switch, a first end of the first switch is coupled to receive the control signal, a second end of the first switch is coupled to receive the analog grey voltage, and a third end of the first switch is coupled to receive the reference voltage; a first end of the second switch is coupled to receive the control signal, a second end of the second switch is coupled to receive the analog grey voltage, and a third end of the second switch is coupled to the data line; wherein, when the control signal is a first control signal, the first switch is turned on and the second switch is turned off to apply the analog grey voltage to the data line through the first switch, and, when the control signal is a second control signal, the first switch is turned off and the second switch is turned on to apply the reference voltage to the data line through the second switch.

Wherein, one of the first switch and the second switch is an NMOS, and another one of the first switch and the second switch is a PMOS.

Wherein, the liquid crystal display apparatus further comprises a buffer, the switch circuit is set between the buffer and the digital to analog converter; when the control signal is the first control signal, the switch circuit is switched to input the analog grey voltage to the buffer so that the analog grey voltage is outputted to the data line after being buffered by the buffer, and, when the control signal is the second control signal, the switch circuit is switched to input the reference voltage to the buffer so that the reference voltage is outputted to the data line after being buffered by the buffer.

Wherein, the liquid crystal display apparatus is a three-dimensional display apparatus, the normal image frame is a left-eye image frame and a right-eye image frame, and the inserted black frame is between the neighbored left-eye image frame and right-eye image frame.

Wherein, the liquid crystal display apparatus further comprises a plurality of pixel electrodes and a common electrode disposed oppositely to the pixel electrodes, wherein the pixel electrodes are coupled to the corresponded data lines, a common voltage is applied on the common electrode, and the reference voltage is equal to the common voltage.

In order to solve the problem mentioned above, a control method of a liquid crystal display apparatus provided by the present invention comprises: applying an analog grey voltage to a data line in response to a first control signal so as to display a normal image frame by the liquid crystal display apparatus; and applying a reference voltage to the data line in response to a second control signal so as to display an inserted black frame by the liquid crystal display apparatus.

Wherein, the step of applying the analog grey voltage to the data line in response to the first control signal comprises: controlling to turn on a first switch and turn off a second switch by the first control signal so that the analog grey voltage is applied to the data line through the first switch; and the step of applying the reference voltage to the data line in response to the second control signal comprises: controlling to turn off the first switch and turn on the second switch by the second control signal so that the reference voltage is applied to the data line through the second switch.

Wherein, one of the first switch and the second switch is an NMOS, and another one of the first switch and the second switch is a PMOS.

Wherein, the step of applying the analog grey voltage to the data line in response to the first control signal comprises: when the control signal is the first control signal, the analog grey voltage is inputted to the buffer so that the analog grey voltage is outputted to the data line after being buffered by the buffer; and the step of applying the reference voltage to the data line in response to the second control signal comprises: when the control signal is the second control signal, the reference voltage is inputted to the buffer so that the reference voltage is outputted to the data line after being buffered by the buffer.

Wherein, the liquid crystal display apparatus is a three-dimensional display apparatus, the normal image frame is a left-eye image frame and a right-eye image frame, and the inserted black frame is between the neighbored left-eye image frame and right-eye image frame.

Wherein, the reference voltage is equal to a common voltage applied on a common electrode of the liquid crystal display apparatus.

Through the solution above, the efficacy of the present invention is that, different from the prior arts and in the present invention, the digital to analog converter in the liquid crystal display apparatus is disposed with a plurality of digital to analog converting channels corresponding to a plurality of data lines for converting a plurality of digital grey voltages into a plurality of analog grey voltages applied on the data lines, respectively; and the switch circuit receives a control signal and switches in accordance with the control signal, wherein the switch circuit is switched to apply the analog grey voltages to the data lines when the control signal is a first control signal so as to display a normal image frame by the liquid crystal display apparatus, and is switched to apply a reference voltage to the data lines when the control signal is a second control signal so as to display an inserted black frame by the liquid crystal display apparatus. Accordingly, the crosstalk generated therefrom can be effectively reduced, power consumption generated due to displaying black frames is saved, and the response of a next frame is faster.

### BRIEF DESCRIPTION OF THE DRAWINGS

In order to clearly describe the technique solution of the present invention, the figures have to be used in the embodiments would be briefly introduced below. Obviously, the figures described below are only some embodiments of the present invention. Other figures can be obtained from the figures below by those with ordinary skill in the technique field without creative efforts. Wherein:

FIG. 1 is a schematic diagram of the liquid crystal display apparatus according to an embodiment of the present invention.

FIG. 2 is a schematic diagram of a switch circuit according to an embodiment of the present invention.

FIG. 3 is a diagram illustrating display of the liquid crystal display apparatus according to an embodiment of the present invention.

FIG. 4 is a flow chart of the control method of the liquid crystal display apparatus according to an embodiment of the present invention.

### DETAILED DESCRIPTION OF PREFERRED EMBODIMENTS

The technique solutions in the embodiments of the present invention are described clearly and completely below with reference to the attached drawings of the embodiments of the present invention. Obviously, the embodiments described below are a part of embodiments but not all embodiments of the present invention. All other embodiments obtained by those have ordinary skill in the field based on the embodiments of the present invention without creative effort are within the protection scope of the present invention.

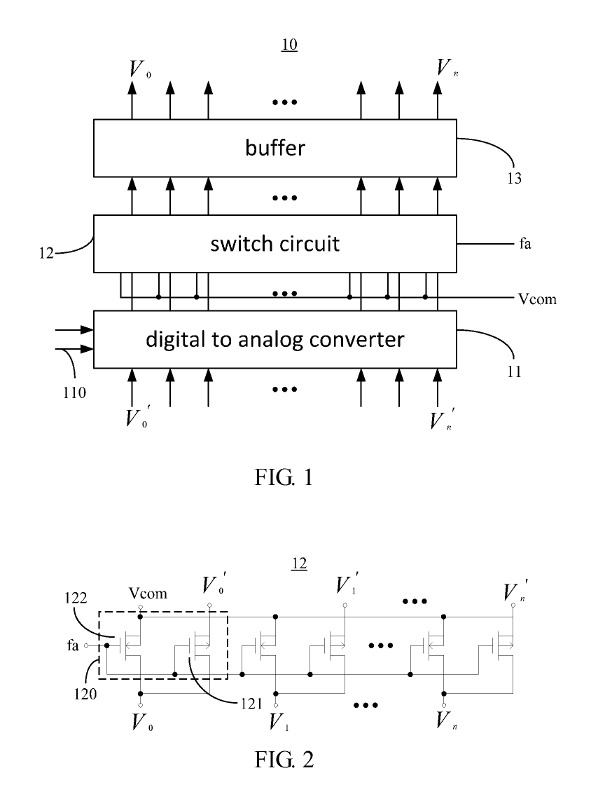

Please refer to FIG. 1, which is a schematic diagram of the liquid crystal display apparatus according to an embodiment of the present invention. As shown in FIG. 1, the liquid crystal display apparatus 10 comprises a plurality of data lines V₀, V₁, . . . Vₙ, a digital to analog converter 11 and a switch circuit 12. The digital to analog converter 11 is disposed with a plurality of digital to analog converting channels 110 corresponding to the data lines V₀, V₁, . . . Vₙ for converting a plurality of digital grey voltages into a plurality of analog grey voltages V′₀, V′₁, . . . V′ₙ applied on the corresponded data lines V₀, V₁, . . . Vₙ, respectively. The switch circuit 12 receives a control signal fa and switches in accordance with the control signal fa, wherein the switch circuit 12 is switched to apply the analog grey voltages V′₀, V′₁, . . . V′ₙ to the data lines V₀, V₁, . . . Vₙ when the control signal fa is a first control signal so as to display a normal image frame by the liquid crystal display apparatus 10, and the switch circuit 12 is switched to apply a reference voltage Vcom to the data lines V₀, V₁, . . . Vₙ when the control signal fa is a second control signal so as to display an inserted black frame by the liquid crystal display apparatus 10. Wherein, the first control signal means the control signal fa is low level, and the second control signal means the control signal fa is high level. The reference voltage Vcom is a common voltage of the liquid crystal display apparatus 10. Accordingly, the digital to analog converting channels need not operate when the liquid crystal display apparatus 10 inserts the black frames, and therefore the display power consumption generated due to inserting black frames is saved.

In a more specific embodiment, the switch circuit 12 comprises a plurality of switching units 12 corresponding to the digital to analog converting channels, and each switching unit 120 comprises a first switch 121 and a second switch 122. A first end of the first switch 121 is coupled to receive the control signal fa, a second end of the first switch 121 is coupled to receive the analog grey voltage V′₀, V′₁, . . . V′ₙ, and a third end of the first switch 121 is coupled to receive the reference voltage Vcom. A first end of the second switch 122 is coupled to receive the control signal fa, a second end of the second switch 122 is coupled to receive the analog grey voltage V′₀, V′₁, . . . V′ₙ, and a third end of the second switch 122 is coupled to the data line V₀, V₁, . . . Vₙ. Wherein, when the control signal fa is the first control signal, the first switch 121 is turned on and the second switch 122 is turned off to apply the analog grey voltage V′₀, V′₁, . . . V′ₙ to the data line V₀, V₁, . . . Vₙ through the first switch 121 to normally transmit left and right image frames. When the control signal fa is the second control signal, the first switch 121 is turned off and the second switch 122 is turned on to apply the reference voltage Vcom to the data line V₀, V₁, . . . Vₙ through the second switch 122. Wherein, one of the first switch 121 and the second switch 122 is an NMOS, and another one of the first switch 121 and the second switch 122 is a PMOS. The first terminal is a gate, the second terminal is a drain, and the third terminal is a source. Specifically, the first switch 121 is an NMOS and the second switch 122 is a PMOS. Or, the second switch 122 is an NMOS and the first switch 121 is a PMOS.

In the embodiment of the present invention, the liquid crystal display apparatus 10 further comprises a buffer 13, wherein the switch circuit 12 is set between the buffer 13 and the digital to analog converter 11. When the control signal fa is the first control signal, the switch circuit 12 is switched to input the analog grey voltage V′₀, V′₁, . . . V′ₙ to the buffer 13 so that the analog grey voltage V′₀, V′₁, . . . V′ₙ is outputted to the data line V₀, V₁, . . . Vₙ after being buffered by the buffer 13. When the control signal fa is the second control signal, the switch circuit 12 is switched to input the reference voltage Vcom to the buffer 13 so that the reference voltage Vcom is outputted to the data line V₀, V₁, . . . Vₙ after being buffered by the buffer 13, and, at this time, ΔV=Vcom−Vcom=0 such that the liquid crystal display accomplishes delivering black image, i.e. inserting black frame. The liquid crystal display apparatus 10 further comprises a plurality of pixel electrodes (not shown in the figure) and a common electrode (not shown in the figure) disposed oppositely to the pixel electrodes, wherein the pixel electrodes are coupled to the corresponded data lines V₀, V₁, . . . Vₙ, a common voltage is applied on the common electrode, and the reference voltage is equal to the common voltage. In the embodiment of the present invention, when the control signal fa is the second control signal, the first switch 121 is turned off and the second switch 122 is turned on so that the reference voltage Vcom is applied to the data lines V₀, V₁, . . . Vₙ through the second switch 122. At this time, the pixel voltage remains at the common voltage so that the voltage of the next frame varies from the reference voltage Vcom, i.e. varies from the common voltage so that the response of an image can be faster.

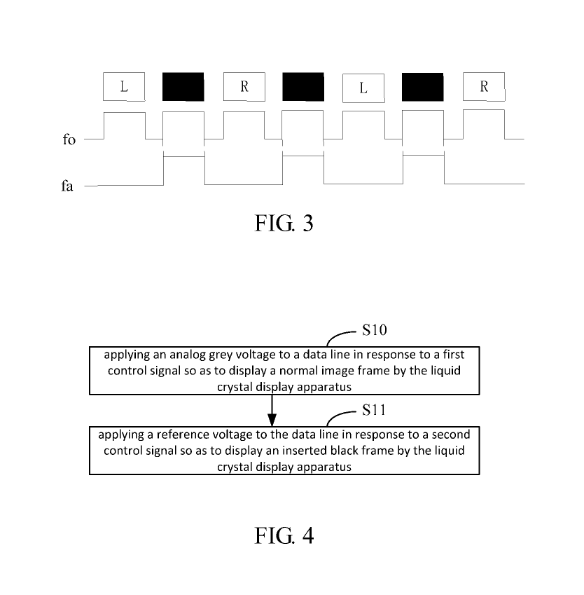

In an embodiment of the present invention, as shown in FIG. 3, the liquid crystal display apparatus 10 is a three-dimensional display apparatus, the normal image frame is a left-eye image frame L and a right-eye image frame R, and the inserted black frame is between the neighbored left-eye image frame L and right-eye image frame R. In this figure, fo represents an image transmitting signal and fa represents a black-image-only transmitting signal. Therefore, while inserting the black frame, it is not necessary to transmit data of black image by transmitting image signal, so that the crosstalk generated therefrom can be reduced effectively, and the power consumption generated due to displaying the black frame can be saved.

FIG. 4 is a flow chart of the control method of the liquid crystal display apparatus according to an embodiment of the present invention. As showing in FIG. 4, the control method of the liquid crystal display apparatus comprises:

Step S10: applying an analog grey voltage to a data line in response to a first control signal so as to display a normal image frame by the liquid crystal display apparatus.

In the step S10, the first control signal controls to turn on a first switch and turn off a second switch so that an analog grey voltage is applied to the data line through the first switch. The left and right image frame is transmitted normally at this time. Specifically, the first control signal controls to turn the first switch on and turn the second switch off, the analog grey voltage is inputted to a buffer, and the analog grey voltage is outputted to the data line after being buffered by the buffer. Wherein, the first control signal is low level.

Step S11: applying a reference voltage to the data line in response to a second control signal so as to display an inserted black frame by the liquid crystal display apparatus.

In the step S11, the second control signal controls to turn off the first switch and turn on the second switch so that the reference voltage is applied to the data line through the second switch. Specifically, the second control signals controls to turn the first switch off and turn the second switch on, the reference voltage Vcom is inputted to the buffer, and the reference voltage Vcom is outputted to the data line after being buffered by the buffer, and, at this time, ΔV=Vcom−Vcom=0 such that the liquid crystal display accomplishes delivering black image, i.e. inserting black frame. Wherein, the reference voltage is equal to the common voltage applied on the common electrode of the liquid crystal display apparatus. Wherein, the second control signal is high level. In the embodiment of the present invention, one of the first switch and the second switch is an NMOS, and another one of the first switch and the second switch is a PMOS. Specifically, the first switch is an NMOS and the second switch is a PMOS. Or, the second switch is an NMOS and the first switch is a PMOS. The liquid crystal display apparatus further comprises a plurality of pixel electrodes and a common electrode disposed oppositely to the pixel electrodes, wherein the pixel electrodes are coupled to the corresponded data lines, and a common voltage, which is equal to the reference voltage, is applied to the common electrode. When the first switch is controlled to be turned off and the second switch is controlled to be turned on by the second control signal, the reference voltage Vcom, which remains at the common voltage at this time, is applied to the data line through the second switch so that the image voltage of the next frame begins to vary from the reference voltage Vcom, i.e. to vary from the common voltage, so that the images are faster correspondingly.

In an embodiment of the present invention, the liquid crystal display apparatus is a three-dimensional display apparatus, the normal image frame is a left-eye image frame and a right-eye image frame, and the inserted black frame is between the neighbored left-eye image frame and right-eye image frame. While inserting the black frame, it is not necessary to transmit data of black image by transmitting image signal, so that the crosstalk generated therefrom can be reduced effectively, and the power consumption generated due to displaying the black frame can be saved.

In summary, different from the conventional technique, the digital to analog converter in the liquid crystal display apparatus of the present invention is disposed with a plurality of digital to analog converting channels corresponding to a plurality of data lines for converting a plurality of digital grey voltages into a plurality of analog grey voltages applied on the data lines, respectively; and the switch circuit receives a control signal and switches in accordance with the control signal, wherein the switch circuit is switched to apply the analog grey voltages to the data lines when the control signal is a first control signal so as to display a normal image frame by the liquid crystal display apparatus, and is switched to apply a reference voltage to the data lines when the control signal is a second control signal so as to display an inserted black frame by the liquid crystal display apparatus. Accordingly, the crosstalk generated therefrom can be effectively reduced, power consumption generated due to displaying black frames is saved, and the response of a next frame is faster.

The descriptions made above are the embodiments of the present invention, and are not used for limiting the protection scope of the present invention. All equivalent structures or process variations made according to the contents of the specification and attached drawings of the present invention, or applying, either directly or indirectly, them into other related technique fields, are included in the patent protection scope of the present invention.

What is claimed is:

1. A liquid crystal display apparatus, comprising:
a plurality of data lines;
a digital to analog converter disposed with a plurality of digital to analog converting channels corresponding to the data lines for converting a plurality of digital grey voltages into a plurality of analog grey voltages applied on the data lines, respectively; and
a switch circuit, which receives a control signal and switches in accordance with the control signal, wherein the switch circuit is switched to apply the analog grey voltages to the data lines when the control signal is a first control signal so as to display a normal image frame by the liquid crystal display apparatus, and is switched to apply a reference voltage to the data lines when the control signal is a second control signal so as to display an inserted black frame by the liquid crystal display apparatus;
wherein, the switch circuit comprises a plurality of switching units corresponding to the digital to analog converting channels, each switching unit comprises a first switch and a second switch, a first end of the first switch is coupled to receive the control signal, a second end of the first switch is coupled to receive the analog grey voltage, and a third end of the first switch is coupled to receive the reference voltage; a first end of the second switch is coupled to receive the control signal, a second end of the second switch is coupled to receive the analog grey voltage, and a third end of the second switch is coupled to the data line; wherein, when the control signal is a first control signal, the first switch is turned on and the second switch is turned off to apply the analog grey voltage to the data line through the first switch, and, when the control signal is a second control signal, the first switch is turned off and the second switch is turned on to apply the reference voltage to the data line through the second switch; the liquid crystal display apparatus is a three-dimensional display apparatus, the normal image frame is a left-eye image frame and a right-eye image frame, and the inserted black frame is between the neighbored left-eye image frame and right-eye image frame.

2. The liquid crystal display apparatus according to claim 1, wherein one of the first switch and the second switch is an NMOS, and another one of the first switch and the second switch is a PMOS.

3. The liquid crystal display apparatus according to claim 1, wherein the liquid crystal display apparatus further comprises a buffer, the switch circuit is set between the buffer and the digital to analog converter; when the control signal is the first control signal, the switch circuit is switched to input the analog grey voltage to the buffer so that the analog grey voltage is outputted to the data line after being buffered by the buffer, and, when the control signal is the second control signal, the switch circuit is switched to input the reference voltage to the buffer so that the reference voltage is outputted to the data line after being buffered by the buffer.

4. The liquid crystal display apparatus according to claim 1, wherein the liquid crystal display apparatus further comprises a plurality of pixel electrodes and a common electrode disposed oppositely to the pixel electrodes, wherein the pixel electrodes are coupled to the corresponded data lines, a common voltage is applied on the common electrode, and the reference voltage is equal to the common voltage.

5. A liquid crystal display apparatus, comprising:
a plurality of data lines;
a digital to analog converter disposed with a plurality of digital to analog converting channels corresponding to the data lines for converting a plurality of digital grey voltages into a plurality of analog grey voltages applied on the data lines, respectively; and
a switch circuit, which receives a control signal and switches in accordance with the control signal, wherein the switch circuit is switched to apply the analog grey voltages to the data lines when the control signal is a first control signal so as to display a normal image frame by the liquid crystal display apparatus, and is switched to apply a reference voltage to the data lines when the control signal is a second control signal so as to display an inserted black frame by the liquid crystal display apparatus.

6. The liquid crystal display apparatus according to claim 5, wherein the switch circuit comprises a plurality of switching units corresponding to the digital to analog converting channels, each switching unit comprises a first switch and a second switch, a first end of the first switch is coupled to receive the control signal, a second end of the first switch is coupled to receive the analog grey voltage, and a third end of the first switch is coupled to receive the reference voltage; a first end of the second switch is coupled to receive the control signal, a second end of the second switch is coupled to receive the analog grey voltage, and a third end of the second switch is coupled to the data line; wherein, when the control signal is a first control signal, the first switch is turned on and the second switch is turned off to apply the analog grey voltage to the data line through the first switch, and, when the control signal is a second control signal, the first switch is turned off and the second switch is turned on to apply the reference voltage to the data line through the second switch.

7. The liquid crystal display apparatus according to claim 5, wherein one of the first switch and the second switch is an NMOS, and another one of the first switch and the second switch is a PMOS.

8. The liquid crystal display apparatus according to claim 5, wherein the liquid crystal display apparatus further comprises a buffer, the switch circuit is set between the buffer and the digital to analog converter; when the control signal is the first control signal, the switch circuit is switched to input the analog grey voltage to the buffer so that the analog grey voltage is outputted to the data line after being buffered by the buffer, and, when the control signal is the second control signal, the switch circuit is switched to input the reference voltage to the buffer so that the reference voltage is outputted to the data line after being buffered by the buffer.

9. The liquid crystal display apparatus according to claim 5, wherein the liquid crystal display apparatus is a three-dimensional display apparatus, the normal image frame is a left-eye image frame and a right-eye image frame, and the inserted black frame is between the neighbored left-eye image frame and right-eye image frame.

10. The liquid crystal display apparatus according to claim 5, wherein the liquid crystal display apparatus further comprises a plurality of pixel electrodes and a common electrode disposed oppositely to the pixel electrodes, wherein the pixel electrodes are coupled to the corresponded data lines, a common voltage is applied on the common electrode, and the reference voltage is equal to the common voltage.

11. A control method of a liquid crystal display apparatus, wherein the control method comprises:
applying an analog grey voltage to a data line in response to a first control signal so as to display a normal image frame by the liquid crystal display apparatus; and
applying a reference voltage to the data line in response to a second control signal so as to display an inserted black frame by the liquid crystal display apparatus.

12. The control method according to claim 11, wherein the step of applying the analog grey voltage to the data line in response to the first control signal comprises:
controlling to turn on a first switch and turn off a second switch by the first control signal so that the analog grey voltage is applied to the data line through the first switch;
the step of applying the reference voltage to the data line in response to the second control signal comprises:
controlling to turn off the first switch and turn on the second switch by the second control signal so that the reference voltage is applied to the data line through the second switch.

13. The control method according to claim 12, wherein one of the first switch and the second switch is an NMOS, and another one of the first switch and the second switch is a PMOS.

14. The control method according to claim 11, wherein
the step of applying the analog grey voltage to the data line in response to the first control signal comprises: when the control signal is the first control signal, the analog grey voltage is inputted to the buffer so that the analog grey voltage is outputted to the data line after being buffered by the buffer; and
the step of applying the reference voltage to the data line in response to the second control signal comprises: when the control signal is the second control signal, the reference voltage is inputted to the buffer so that the reference voltage is outputted to the data line after being buffered by the buffer.

15. The control method according to claim 11, wherein the liquid crystal display apparatus is a three-dimensional display apparatus, the normal image frame is a left-eye image frame and a right-eye image frame, and the inserted black frame is between the neighbored left-eye image frame and right-eye image frame.

16. The control method according to claim 11, wherein the reference voltage is equal to a common voltage applied on a common electrode of the liquid crystal display apparatus.
